(19) United States
(12) Patent Application Publication
(10) Pub. No.: US 2026/0268526 A1
(43) Pub. Date: Sep. 10, 2026

(54) INFORMATION PROCESSING DEVICE AND PROGRAM

(71) Applicant: Masaaki TAKAYAMA, Osaka (JP)

(72) Inventor: Masaaki TAKAYAMA, Osaka (JP)

(21) Appl. No.: 19/164,996

(22) PCT Filed: Mar. 12, 2024
(86) PCT No.: PCT/JP2024/009560

§ 371 Date: Sep. 12, 2025

(30) Foreign Application Priority Data
Mar. 14, 2023 (JP) 2023-039960
Mar. 8, 2024 (JP) 2024-035575

(51) Int. Cl. G06T 7/90; G06T 7/00

(52) U.S. Cl. CPC G06T 7/90; G06T 7/0012; G06T 2207/10024; G06T 2207/10081; G06T 2207/10116; G06T 2207/30036; G06T 2207/30104

(57) ABSTRACT

A server (200) includes an acquisition unit (211), an identification unit (212), a detection unit (213), a storage unit (220), a determination unit (214), and a communication unit (201). The acquisition unit (211) acquires image data representing an image (I50) capturing a tooth. The identification unit (212) identifies a region (I50a) of the tooth in the image (I50). The detection unit (213) detects a target color value indicating the color of the tooth region (I50a). The storage unit (220) stores associated data (D1) in which a reference color value and a reference item value are associated. The determination unit (214) determines a target item value based on the target color value and the associated data (D1). The communication unit (201) outputs the target item value.

### TECHNICAL FIELD

The present invention relates to an information processing device and a program.

### BACKGROUND ART

Conventionally, information processing devices for measuring the color of teeth have been known (refer to Patent Document 1 as an example). Patent Document 1 discloses a whitening measurement system for measuring changes in whiteness after tooth whitening treatment. In the whitening measurement system described in Patent Document 1, images of the same tooth are captured before and after whitening. The user selects the same area of the same tooth in each image, and the system calculates the average color value of the selected area. This allows the degree of whitening to be numerically displayed to the user.

### CITATION LIST

### Patent Literature

Patent Literature 1: Japanese Unexamined Patent Application Publication No. 2017-23653

### SUMMARY OF INVENTION

### Problem to be Solved by Invention

However, in the whitening measurement system described in Patent Document 1, the user must select the same area in the same tooth image, which is cumbersome. Furthermore, the system merely displays the numerical degree of whitening and does not make full use of the detected tooth color results.

The present invention has been made in view of the above problems, and an object thereof is to provide an information processing device and a program capable of efficiently detecting and utilizing tooth color.

### Means for Solving Problem

According to one aspect of the present invention, an information processing device includes an acquisition unit, an identification unit, a detection unit, a storage unit, a determination unit, and an output unit. The acquisition unit acquires image data representing an image capturing a tooth. The identification unit identifies a tooth region in the image. The detection unit detects a target color value indicating the color of the tooth region. The storage unit stores associated data in which a reference color value is associated with a reference item value. The determination unit determines a target item value based on the target color value and the associated data. The output unit outputs the target item value.

In one embodiment of the present invention, the reference item value may include a tooth age. The target item value may include the tooth age of the tooth region.

In one embodiment of the present invention, the reference item value may include an identification number of a shade guide. The target item value may include the identification number of the shade guide corresponding to the tooth region.

In one embodiment of the present invention, the reference item value may include an evaluation value. The target item value may include the evaluation value of the tooth region.

In one embodiment of the present invention, the acquisition unit may acquire brightness information related to brightness at the time of imaging the tooth. The determination unit may determine the target item value based on the brightness information, the target color value, and the associated data.

In one embodiment of the present invention, the acquisition unit may acquire at least one of nationality information and racial information of the person being imaged. The associated data may associate the reference color value and the reference item value with at least one of the nationality information and racial information. The determination unit may determine the target item value based on the target color value, the associated data, and at least one of the nationality information and racial information.

In one embodiment of the present invention, the acquisition unit may acquire age information of the person being imaged. The associated data may associate the reference color value and the reference item value with the age information. The determination unit may determine the target item value based on the target color value, the associated data, and the age information.

In one embodiment of the present invention, the determination unit may determine the target item value based on the area or volume of the tooth region.

In one embodiment of the present invention, the identification unit may identify a region of a maxillary central incisor and a region of a maxillary lateral incisor in the image. The determination unit may determine the target item value based on a ratio between the width of the maxillary central incisor region and the width of the maxillary lateral incisor region.

In one embodiment of the present invention, the information processing device may further include a determination unit configured to determine whether the person in the image is facing forward. The identification unit may identify the tooth region in an image in which it is determined that the person is facing forward.

In one embodiment of the present invention, the information processing device may include an imaging unit configured to capture an image of a tooth. The output unit may include a display unit configured to display the target item value.

According to another aspect of the present invention, a program causes a computer to execute: a step of acquiring image data representing an image capturing a tooth; a step of identifying a tooth region in the image; a step of detecting a target color value representing the color of the tooth region; a step of determining a target item value based on the target color value and associated data in which reference color values are associated with reference item values; and a step of outputting the target item value.

### Effects of Invention

According to the present invention, it is possible to provide an information processing device and a program capable of efficiently detecting and utilizing tooth color.

### BRIEF DESCRIPTION OF DRAWINGS

FIG. 1 It is a schematic diagram showing the overall configuration of the information processing system according to the first embodiment.

FIG. 2 It is a block diagram showing the overall configuration of the information processing system according to the first embodiment.

FIG. 3 It is a schematic diagram showing an example of an image I50 captured by the imaging unit. FIG. 3(a) shows an example in which the target region I50b is a single region spanning multiple tooth regions. FIG. 3(b) shows an example in which the target region I50b corresponds to a single specific tooth region. FIG. 3(c) shows an example in which the target region I50b includes multiple regions corresponding to individual tooth regions.

FIG. 4 It is a partially enlarged view of an example of the image I50.

FIG. 5 It is a diagram showing the associated data in the first embodiment.

FIG. 6 It is a flowchart showing the processing flow of the mobile terminal in the first embodiment.

FIG. 7 It is a diagram showing an example of a state in which an image I53 indicating tooth age is displayed on the display unit of the mobile terminal.

FIG. 8 It is a flowchart showing the processing flow of the server in the first embodiment.

FIG. 9 It is a diagram showing associated data in a first modification.

FIG. 10 It is a diagram showing an example of a state in which an image I54 indicating the identification number of a shade guide is displayed on the display unit of the mobile terminal.

FIG. 11 It is a block diagram showing the configuration of the mobile terminal in the second embodiment.

FIG. 12 It is a flowchart showing the processing flow of the mobile terminal in the second embodiment.

FIG. 13 It is a diagram showing an example of an image displayed on the display unit of the mobile terminal in the third embodiment.

FIG. 14 It is a diagram showing an example of an image displayed on the display unit of the mobile terminal in the fourth embodiment.

FIG. 15 It is a diagram showing an example of an image displayed on the display unit of the mobile terminal in the sixth embodiment.

FIG. 16 It is a partially enlarged view of an example image in the seventh embodiment.

FIG. 17 It is a side view schematically showing the information processing system in the eighth embodiment.

FIG. 18 It is a block diagram showing the configuration of the information processing system in the eighth embodiment.

FIG. 19 It is a flowchart showing the processing flow of the information processing system in the eighth embodiment.

### DETAILED DESCRIPTION OF EMBODIMENTS

Hereinafter, embodiments of the present invention will be described with reference to the drawings. However, the present invention is not limited to the following embodiments and can be implemented in various forms without departing from the spirit of the invention. Note that repetitive explanations may be omitted as appropriate. In the drawings, the same or corresponding parts are denoted by the same reference numerals, and duplicate explanations thereof are omitted.

### First Embodiment

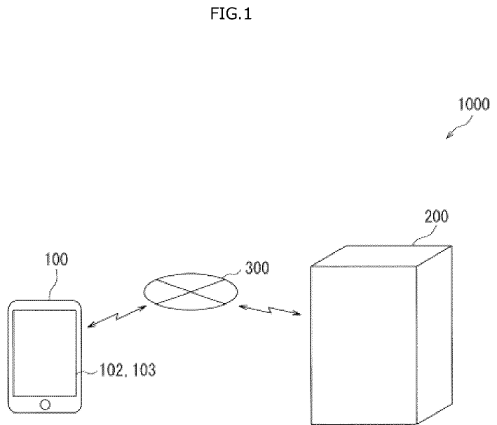

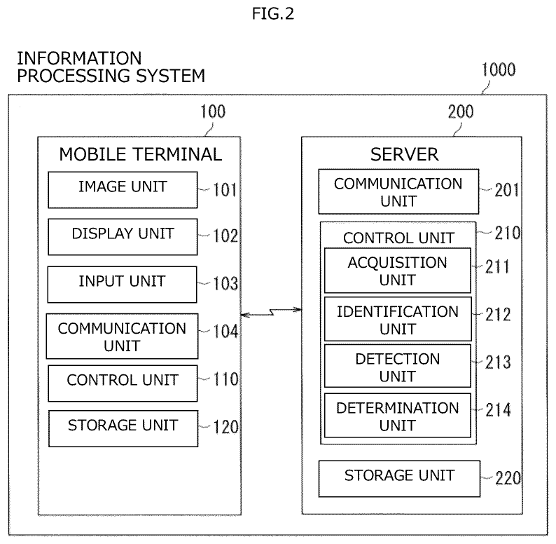

The information processing system 1000 according to a first embodiment of the present invention will be described with reference to FIGS. 1 to 8. FIG. 1 is a schematic diagram showing the overall configuration of the information processing system 1000 according to the first embodiment. FIG. 2 is a block diagram showing the overall configuration of the information processing system 1000 according to the first embodiment.

As shown in FIG. 1 and FIG. 2, the information processing system 1000 includes a mobile terminal 100 and a server 200. The mobile terminal 100 may be, for example, a smartphone or a tablet device. In the present embodiment, the mobile terminal 100 is a smartphone. Note that in the present embodiment, the server 200 is one example of the “information processing device” of the present invention.

The mobile terminal 100 communicates with the server 200 via a communication network 300. The mobile terminal 100 may be connected to the communication network 300, for example, via a router (not shown). Alternatively, it may be connected to the communication network 300 without a router. The communication network 300 may include, for example, the Internet and a public telephone network.

As shown in FIG. 2, the mobile terminal 100 includes an imaging unit 101, a display unit 102, an input unit 103, a communication unit 104, a control unit 110, and a storage unit 120.

The imaging unit 101 captures an image of a target object. The imaging unit 101 is used, for example, to capture an image of a region including teeth. The imaging unit 101 generates image data representing a captured image. The generated image data is stored in the storage unit 120. The imaging unit 101 includes, for example, a camera with an imaging element such as a CCD image sensor or a CMOS image sensor. The imaging unit 101 may also include a thermographic camera for detecting surface temperature or blood flow. Furthermore, the imaging unit 101 may include an X-ray imaging device such as a 3D scanner, computed tomography (CT), or panoramic X-ray imaging device. The imaging unit 101 may also include an intraoral camera, or any other type of camera. The imaging unit 101 may include two or more types of cameras.

The display unit 102 displays various images. For example, the display unit 102 displays the captured image obtained by the imaging unit 101. It may also display various setting screens (input screens), and images that function as buttons. The display unit 102 includes, for example, a display panel such as a liquid crystal display (LCD) or an organic electroluminescence (EL) display.

The input unit 103 receives user input operations. It may include physical keys, or may include a touch panel arranged on the display unit 102. In the present embodiment, the input unit 103 includes a touch panel arranged on the display unit 102. The input unit 103 and the display unit 102 together form a touch display.

The communication unit 104 is an interface device for wireless communication. It includes, for example, a wireless communication module conforming to a wireless communication standard defined by Wi-Fi®.

The control unit 110 includes a processor. It may include, for example, a CPU (Central Processing Unit) or an MPU (Micro Processing Unit). Alternatively, it may include a general-purpose or dedicated computation unit.

The control unit 110 controls communication with the server 200 via the communication unit 104. It also controls screen transitions on the display unit 102 based on operations performed by the user via the input unit 103. Furthermore, based on the data and computer programs stored in the storage unit 120, it controls the operations of various components of the mobile terminal 100.

The storage unit 120 stores data and computer programs. It stores, for example, image data representing the image captured by the imaging unit 101. It includes a main storage device, such as a semiconductor memory. The storage unit 120 may further include an auxiliary storage device, such as a semiconductor memory and/or a hard disk drive. It may also include removable media.

The server 200 transmits and receives various types of information to and from the mobile terminal 100 via the communication network 300. The server 200 is configured by one or more computers.

The server 200 includes a communication unit 201, a control unit 210, and a storage unit 220. The communication unit 201 is an interface device for wireless communication and includes, for example, a wireless communication module conforming to Wi-Fi® standards. In the present embodiment, the communication unit 201 is an example of the “output unit” of the present invention.

The control unit 210 includes a processor. It may include a CPU or an MPU. Alternatively, it may include a general-purpose or dedicated computation unit.

The control unit 210 controls communication with the mobile terminal 100 via the communication unit 201. It also controls the operations of various components of the server 200 based on the data and computer programs stored in the storage unit 220.

The storage unit 220 stores data and computer programs. It includes a main storage device, such as a semiconductor memory. It may also include an auxiliary storage device, such as a semiconductor memory and/or a hard disk drive. It may include removable media as well.

The storage unit 220 stores, for example, image data transmitted from the mobile terminal 100. It also stores, for example, associated data described later.

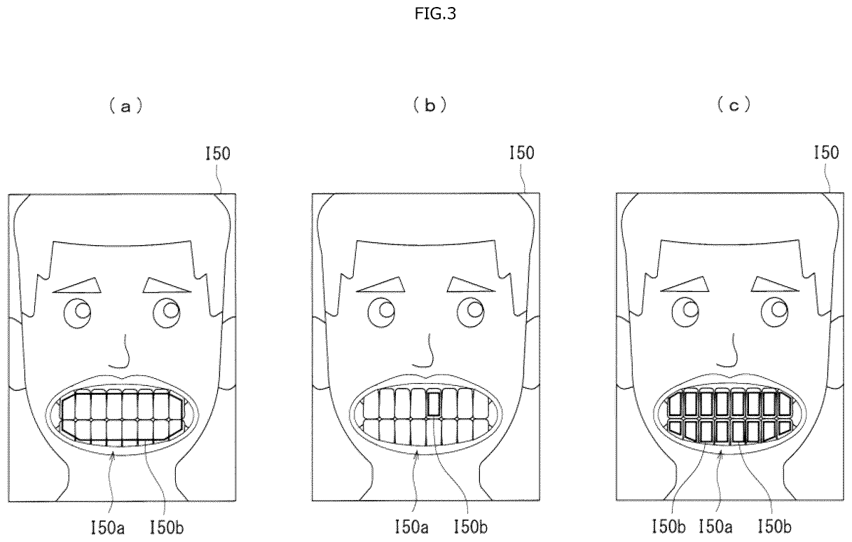

Next, with reference to FIGS. 2 to 5, the control unit 210 of the server 200 will be described. FIG. 3 is a schematic diagram showing an example of an image I50 captured by the imaging unit 101. FIG. 3(a) shows an example in which the target region I50b spans multiple tooth regions (in this case, all teeth within image I50). FIG. 3(b) shows an example in which the target region I50b corresponds to one specific tooth region. FIG. 3(c) shows an example in which the target region I50b includes multiple regions corresponding to individual teeth.

The control unit 210 includes an acquisition unit 211, an identification unit 212, a detection unit 213, and a determination unit 214.

The acquisition unit 211 acquires image data from the mobile terminal 100. The image data includes, for example, image data captured by the imaging unit 101 from the front of the subject (the target person). The image data represents an image I50 (see FIG. 3) captured by the imaging unit 101 of the person's teeth. That is, the acquisition unit 211 acquires image data representing the image I50 in which the teeth are captured. The acquired image data is stored in the storage unit 220.

As shown in FIG. 3, the image I50 includes teeth and other parts. In other words, the image I50 includes a tooth region (region indicating the teeth) I50a and a region indicating parts other than teeth. The parts other than teeth may include, for example, gums, lips, cheeks, nose, jaw, and eyes. Additionally, the parts other than teeth may further include the background and other elements.

The identification unit 212 identifies the tooth region I50a in the image I50. The identification unit 212 distinguishes between the tooth region I50a and non-tooth regions in the image I50. For example, it may identify the boundary between the tooth region I50a and the non-tooth regions. The identification unit 212 may identify the tooth region I50a by performing predetermined processing on the image data representing the image I50. It may also identify the tooth region I50a based on image data indicating surface temperature and/or blood flow. Furthermore, the identification unit 212 may identify a white region surrounded by red or pink regions as the tooth region I50a. Alternatively, it may identify the tooth region I50a based on image data captured by CT or X-ray imaging devices.

The identification unit 212 may also identify the tooth region I50a using a trained model. In this case, the identification unit 212 inputs the image data into the trained model to obtain the tooth region I50a.

Specifically, the trained model is a model trained using a training program and a training dataset. The training dataset includes, for example, between several dozen and several tens of thousands of image data items and corresponding data indicating the tooth region I50a for each image. The training dataset may also include image data without any tooth region I50a. The trained model may be generated by the server 200 or may be acquired by the server 200 after being generated by a machine learning device.

The machine learning algorithm used to generate the trained model is not particularly limited and may include, for example, decision trees, nearest neighbor methods, naïve Bayes classifiers, support vector machines (SVM), or neural networks. Therefore, the trained model may include one or more of these algorithms.

In the present embodiment, the machine learning algorithm used to generate the trained model is a neural network. That is, the trained model includes a neural network. The neural network includes an input layer, one or more hidden layers, and an output layer. Preferably, the neural network is a deep neural network (DNN), recurrent neural network (RNN), or convolutional neural network (CNN), and performs deep learning.

Although in the present embodiment the machine learning is supervised learning, it may alternatively be unsupervised learning, semi-supervised learning, reinforcement learning, or deep learning.

If the identification unit 212 fails to detect the tooth region I50a in the image I50, the control unit 210 may output an error signal. In other words, if the image I50 does not contain teeth, the control unit 210 may detect an error.

The detection unit 213 detects a target color value representing the color of the tooth region I50a. Specifically, the detection unit 213 detects the target color value representing the color of a target region I50b within the tooth region I50a.

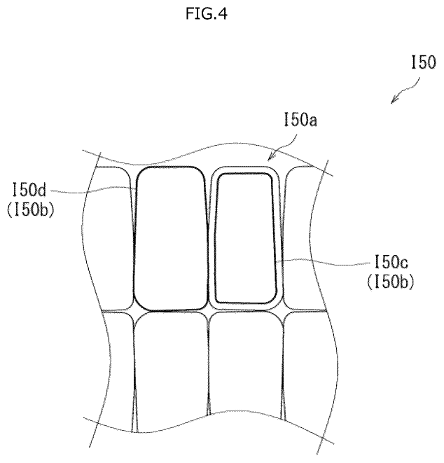

FIG. 4 is a partial enlarged view of an example of the image I50. For clarity, in FIGS. 3 and 4, the target region I50b is outlined in bold. The target region I50b may be the same as the tooth region I50a or may be a part of the tooth region I50a. The target region I50b may be a single region or multiple regions.

Specifically, as shown in FIG. 3(a), the target region I50b may be a single region spanning multiple (in this case, all) tooth regions in the image I50. As shown in FIG. 3(b), the target region I50b may correspond to a specific single tooth region. The number of specific teeth may be, for example, one or two. The specific tooth may be an upper front tooth (e.g., a central incisor). As shown in FIG. 3(c), the target region I50b may also be multiple regions corresponding to individual tooth regions.

As shown in FIG. 4, the target region I50b may be slightly smaller than the tooth region I50a (refer to region I50c). In other words, the target region I50b is a region of the tooth region I50a excluding the edges of the tooth. The target region I50b may also be approximately the same size as the tooth region I50a (refer to region I50d).

The detection unit 213 detects the color value of one or more points within the target region I50b. In the present embodiment, the detection unit 213 detects the color values of multiple (here, several to several dozen) points within the target region I50b. The detection unit 213 then averages the detected color values to derive the target color value representing the color of the target region I50b.

The color value may be, for example, an RGB value or an Lab* value. In this embodiment, the detection unit 213 detects the target color value in RGB values. The color value may also be a value in a color space other than RGB or Lab*.

The determination unit 214 determines a target item value based on the target color value detected by the detection unit 213 and the associated data. The associated data is data in which reference color values are associated with reference item values. The reference color values include, for example, at least one of RGB values or Lab* values.

In this embodiment, the reference item value is, for example, tooth age. Tooth age refers to a numerical value indicating the level of color aging of a tooth corresponding to a certain human age.

Here, tooth color changes with aging. Specifically, due to aging, the dentin becomes darker or the enamel becomes thinner and more translucent, making the dentin visible, causing the tooth color to gradually shift toward yellow or brown. Therefore, in this embodiment, tooth color due to aging is correlated with age and used as associated data.

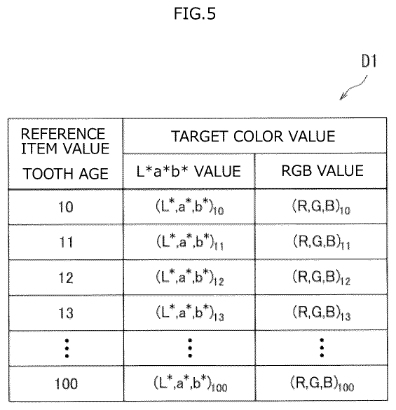

FIG. 5 shows the associated data D1 in the first embodiment. As shown in FIG. 5, the associated data D1 is a data table in which tooth age as a reference item value is associated with Lab* values as reference color values. In the associated data D1, Lab* values corresponding to the tooth age, referred to as “(Lab*)n”, are preconfigured. Here, n is an integer greater than or equal to 1. Tooth age may range, for example, from 1 to 100 years. In this embodiment, it typically ranges from 10 to 100 years. The associated data D1 is a compilation of results obtained by investigating the relationship between actual age and tooth color values for a large number of individuals. It may represent average tooth color values for actual ages of Japanese individuals.

In this embodiment, the associated data D1 further associates Lab* values with RGB values. In other words, the tooth age as a reference item value is associated with both RGB and Lab* values as reference color values. Although both values may be associated, it is also acceptable for only one of the two (Lab* or RGB) to be associated with the tooth age.

The associated data may be in a form other than a data table as long as the reference color value and reference item value are associated. For example, it may be a mathematical formula that calculates the reference item value from a reference color value, or a trained model that outputs the reference item value when a reference color value is input.

The determination unit 214 selects the reference color value closest to the target color value detected by the detection unit 213, based on the associated data D1. Specifically, in this embodiment, the determination unit 214 converts the target color value detected in RGB into Lab* value. The method of converting from RGB to Lab* may be a known method.

The determination unit 214 selects the reference color value in the associated data D1 that is closest to the converted Lab* value. Specifically, for example, in the Lab* color space (not shown), the determination unit 214 selects the Lab* value (reference color value) that is the shortest distance from the target Lab* value.

Then, the determination unit 214 selects the reference item value corresponding to the selected reference color value from the associated data D1. In this embodiment, the determination unit 214 selects the tooth age (reference item value) corresponding to the selected Lab* value (reference color value). In other words, it determines the tooth age corresponding to the selected reference color value.

The communication unit 201 outputs the information on tooth age determined by the determination unit 214. In this embodiment, the communication unit 201 transmits the tooth age information to the mobile terminal 100. As a result, the display unit 102 of the mobile terminal 100 displays the tooth age.

In this embodiment, because the identification unit 212 identifies the tooth region I50a within the image I50, it is not necessary for the user to manually select the tooth region I50a. Therefore, the process of detecting tooth color is less burdensome.

Additionally, because the detection unit 213 detects the target color value of the tooth region I50a and the determination unit 214 determines the target item value based on the associated data D1 and the target color value, the system can determine the target item value (here, tooth age) based on the detected tooth color.

As a result, tooth color can be efficiently detected and utilized. For example, in a dental clinic, an image of a patient's teeth can be taken and the patient can be informed of their tooth age. If the tooth age is higher than the actual age, the patient may be more inclined to request whitening treatment, leading to an increase in patients and revenue. Additionally, after whitening, a new image can be taken to show the patient that their tooth age has decreased, providing satisfaction.

As described above, the reference item value includes tooth age, and the target item value includes the tooth age of the tooth region I50a. Therefore, the patient's tooth age can be determined based on the color of their teeth.

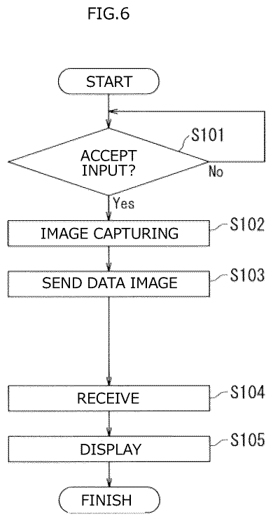

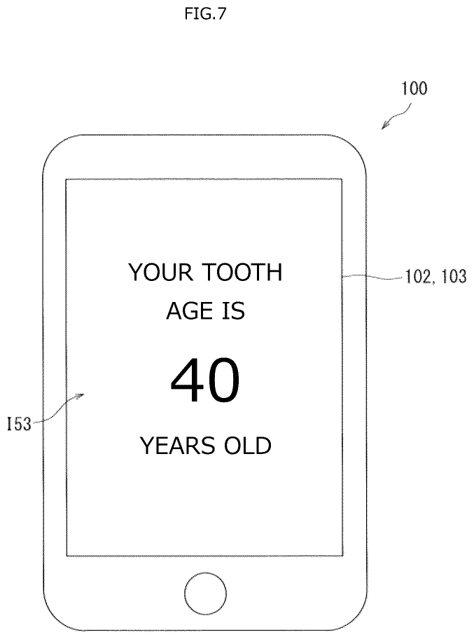

Next, with reference to FIGS. 6 and 7, the processing flow of the mobile terminal 100 in the first embodiment will be described. FIG. 6 is a flowchart showing the processing flow of the mobile terminal 100. FIG. 7 is a diagram showing an example in which an image I53 indicating tooth age is displayed on the display unit 102 of the mobile terminal 100. In this embodiment, the processing flow of the mobile terminal 100 includes steps S101 to S105, which are executed by the control unit 110.

As shown in FIG. 6, in step S101, the control unit 110 determines whether a user input operation has been received. Specifically, the display unit 102 displays a button to start measuring tooth age. When the user wants to start the measurement, they touch the start button. Then, while pointing the camera lens toward the subject (target person), the user touches the shutter button displayed on the display unit 102. Thus, the input unit 103 sends signals indicating that the start button and the shutter button have been touched to the control unit 110. In this case, the control unit 110 receives both signals and determines that the user input operation has been received.

If, in step S101, the control unit 110 determines that no user input operation has been received, the process returns to step S101.

On the other hand, if the control unit 110 determines that user input has been received in step S101, the process proceeds to step S102.

Next, in step S102, the control unit 110 captures an image of the teeth. Specifically, the control unit 110 controls the imaging unit 101 to capture an image of the subject. At this time, the subject (the person being imaged) opens their mouth so that the teeth are visible. Thus, the imaging unit 101 captures the teeth.

Next, in step S103, the control unit 110 transmits the image data representing the captured image to the server 200. Specifically, the control unit 110 uses the communication unit 104 to transmit the image data to the server 200.

Next, in step S104, the control unit 110 receives information regarding the tooth age. Specifically, the control unit 110 uses the communication unit 104 to receive the tooth age information from the server 200.

Next, in step S105, the control unit 110 displays a predetermined image on the display unit 102. Specifically, as shown in FIG. 7, the display unit 102 displays an image I53 indicating the tooth age, based on the received tooth age information. The image I53 includes, for example, a numerical representation of the tooth age. While FIG. 7 shows a single tooth age being displayed, the invention is not limited to this. For example, as shown in FIG. 3(c), if regions I50b are set for each tooth and a tooth age is determined for each region, the tooth ages may be displayed individually for each tooth. In such a case, the image of the teeth and the respective tooth ages may be displayed side by side.

As described above, the processing of the mobile terminal 100 in the first embodiment is completed.

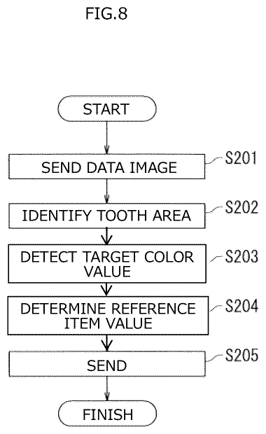

Next, with reference to FIG. 8, the processing flow of the server 200 in the first embodiment will be described. FIG. 8 is a flowchart showing the processing flow of the server 200 in the first embodiment. In this embodiment, the processing flow of the server 200 includes steps S201 to S205, which are executed by the control unit 210.

As shown in FIG. 8, in step S201, the control unit 210 acquires image data. Specifically, the communication unit 201 receives image data from the mobile terminal 100, and the acquisition unit 211 acquires the image data received by the communication unit 201.

Next, in step S202, the control unit 210 identifies the tooth region I50a in the image I50. Specifically, the identification unit 212 identifies the tooth region I50a and the non-tooth regions in the image I50. In this embodiment, the identification unit 212 inputs the image data into a trained model and obtains data indicating the tooth region I50a and the non-tooth regions.

Next, in step S203, the control unit 210 detects the target color value representing the color of the tooth region I50a. Specifically, the detection unit 213 detects the target color value representing the color of the target region I50b within the tooth region I50a.

Next, in step S204, the control unit 210 determines the target item value. In this embodiment, the target item value is the tooth age. Specifically, the determination unit 214 determines the tooth age based on the target color value detected by the detection unit 213 and the associated data D1.

Next, in step S205, the control unit 210 outputs the determined target item value. Specifically, the control unit 210 transmits the determined tooth age information to the mobile terminal 100 via the communication unit 201.

As described above, the processing of the server 200 in the first embodiment is completed.

In the first embodiment, the target region I50b may exclude decayed portions and prosthetic portions. That is, the detection unit 213 may detect the color value of a region excluding decayed and prosthetic portions. In this case, the detection unit 213 may set the target region I50b as the region within the tooth region I50a excluding decayed and prosthetic areas. Alternatively, the identification unit 212 may identify the tooth region I50a excluding decayed and prosthetic areas.

### (First Modification)

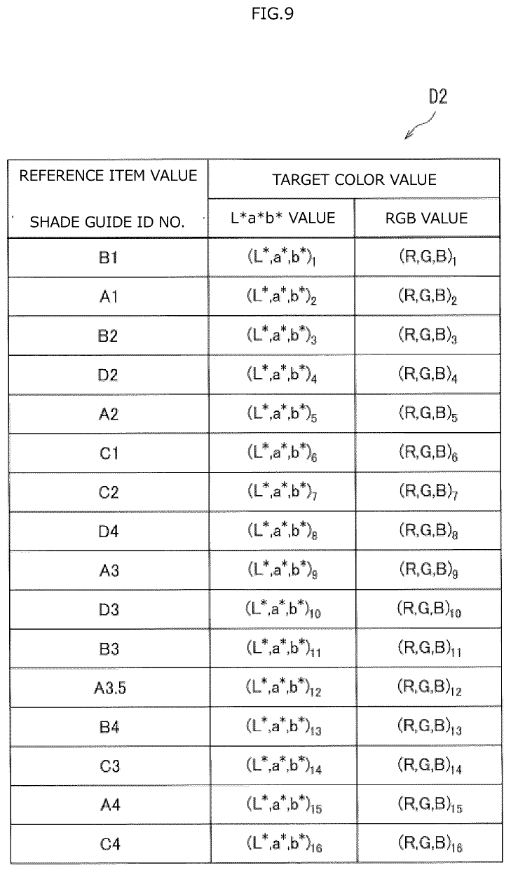

With reference to FIG. 9 and other drawings, the first modification of the information processing system 1000 based on the first embodiment of the present invention will be described. Unlike the first embodiment, this modification describes an example in which the target item value includes a shade guide identification number.

As shown in FIG. 2, in the first modification, the detection unit 213 of the server 200 detects the target color value representing the color of the target region I50b (see FIG. 3) within the tooth region I50a, as in the first embodiment. The method of setting the target region I50b is the same as in the first embodiment. However, the setting method may also differ. For example, in the first modification, the target region I50b may be the region I50a of a tooth adjacent to a missing tooth. That is, the system may detect the color of the tooth next to the missing one.

Similar to the first embodiment, the determination unit 214 determines the target item value based on the target color value detected by the detection unit 213 and the associated data.

Here, in the first modification, the reference item value in the associated data is, for example, the identification number of a shade guide. A shade guide is a set of multiple (e.g., 16) artificial teeth of different colors. The identification number is assigned to each shade in the set. Typically, each tooth model is assigned an identifier such as B1, A1, B2 . . . A4, C4.

FIG. 9 is a diagram showing the associated data D2 in the first modification. As shown in FIG. 9, the associated data D2 associates the identification number of the shade guide (as the reference item value) with an Lab* value (as the reference color value). In the associated data D2, “(Lab*)n” corresponding to each shade guide identification number is preset.

In the first modification, similar to the first embodiment, the associated data D2 associates Lab* values with RGB values. In other words, the shade guide identification number (reference item value) is associated with RGB values (reference color values). Although the shade guide identification number is associated with both Lab* values and RGB values in the associated data D2, it may be associated with only one of them.

The determination unit 214 selects the reference color value closest to the target color value detected by the detection unit 213, based on the associated data D2. Similar to the first embodiment, the determination unit 214 selects the reference color value in the associated data D2 that is closest to the Lab* value converted from the RGB value. Then, the determination unit 214 selects the reference item value corresponding to the selected reference color value. In this modification, the determination unit 214 selects the shade guide identification number (reference item value) corresponding to the selected Lab* value (reference color value) from the associated data D2. In other words, the determination unit 214 determines the shade guide identification number corresponding to the selected reference color value.

The communication unit 201 outputs information related to the shade guide identification number determined by the determination unit 214. In the first modification, the communication unit 201 transmits the shade guide identification number information to the mobile terminal 100. As a result, the shade guide identification number is displayed on the display unit 102 of the mobile terminal 100.

In the first modification, as described above, the reference item value includes a shade guide identification number, and the target item value includes the shade guide identification number corresponding to the tooth region I50a. Therefore, for example, in a dental clinic, when creating a prosthesis or performing whitening treatment, the user (e.g., a dentist) can simply capture an image of the patient's teeth and have the shade guide identification number displayed on the mobile terminal 100. Accordingly, there is no need for the conventional cumbersome task of placing a shade guide next to the patient's mouth and comparing the tooth color visually to determine the corresponding shade guide number. Thus, the burden on both the dentist and the patient can be reduced. Needless to say, in this modification, it is not necessary to place a shade guide near the patient's mouth during imaging.

Other components and effects of the first modification are the same as those of the first embodiment.

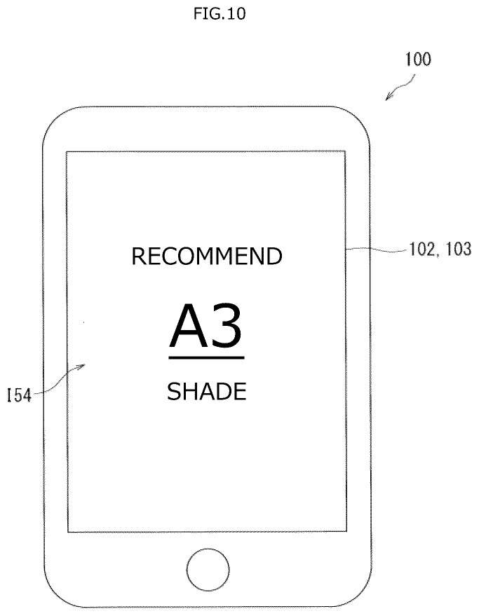

Next, with reference to FIG. 10 and other drawings, the processing flow of the mobile terminal 100 in the first modification will be described. FIG. 10 is a diagram showing an example of a state in which an image I54 indicating the shade guide identification number is displayed on the display unit 102 of the mobile terminal 100.

As shown in FIG. 6, in step S101, the control unit 110 determines whether a user (e.g., a dentist) has performed an input operation. Specifically, a button to start selecting the shade guide identification number closest to the color of the patient's teeth is displayed on the display unit 102. When the user wants to start the selection, they touch the start button. Then, while pointing the camera lens at the subject (the patient), the user touches the shutter button displayed on the display unit 102. Accordingly, the control unit 110 determines that user input has been received.

Next, steps S102 and S103 are executed in the same manner as in the first embodiment.

Next, in step S104, the control unit 110 receives information related to the shade guide identification number. Specifically, the control unit 110 uses the communication unit 104 to receive the shade guide identification number information from the server 200.

Next, in step S105, the control unit 110 displays a predetermined image on the display unit 102. Specifically, as shown in FIG. 10, the control unit 110 displays the image I54 indicating the shade guide identification number based on the received information.

Other parts of the mobile terminal 100's processing flow in the first modification are the same as those in the first embodiment.

Next, with reference to FIG. 8, the processing flow of the server 200 in the first modification will be described.

As shown in FIG. 8, steps S201 to S203 are executed in the same manner as in the first embodiment.

Next, in step S204, the control unit 110 determines the target item value. In the first modification, the target item value is the shade guide identification number. Specifically, the determination unit 214 determines the shade guide identification number based on the target color value detected by the detection unit 213 and the associated data D2.

Next, in step S205, the control unit 110 outputs the determined target item value. Specifically, the control unit 110 transmits the determined shade guide identification number information to the mobile terminal 100 via the communication unit 201.

Other parts of the processing flow of the server 200 in the first modification are the same as those in the first embodiment.

### Second Embodiment

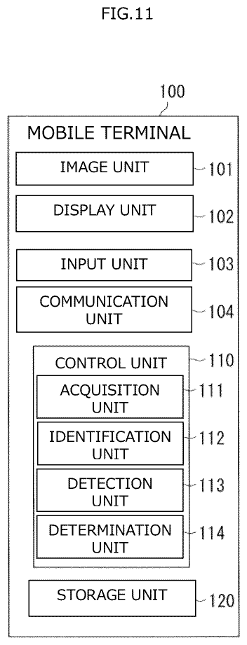

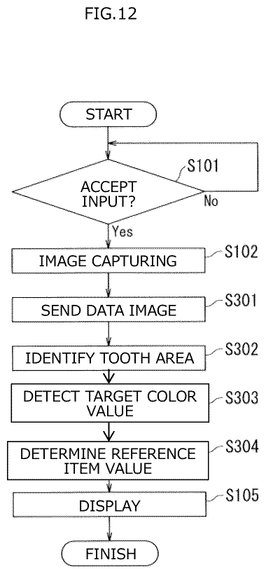

With reference to FIG. 11 and FIG. 12, the mobile terminal 100 according to a second embodiment of the present invention will be described. FIG. 11 is a block diagram showing the configuration of the mobile terminal 100 in the second embodiment. In the second embodiment, unlike the first embodiment, the mobile terminal 100 performs the image processing. In this embodiment, the mobile terminal 100 is an example of the “information processing device” of the present invention.

As shown in FIG. 11, the mobile terminal 100 includes an imaging unit 101, a display unit 102, an input unit 103, a communication unit 104, a control unit 110, and a storage unit 120. In this embodiment, the display unit 102 is an example of the “output unit” of the present invention.

In this embodiment, the storage unit 120 stores the associated data D1.

The control unit 110 includes an acquisition unit 111, an identification unit 112, a detection unit 113, and a determination unit 114.

The acquisition unit 111 acquires image data from the imaging unit 101. The image data represents, for example, the image I50 of the teeth captured by the imaging unit 101. The acquired image data is stored in the storage unit 120. Other configurations of the acquisition unit 111 are the same as those of the acquisition unit 211 in the first embodiment.

The configurations of the identification unit 112, detection unit 113, and determination unit 114 are the same as those of the identification unit 212, detection unit 213, and determination unit 214 in the first embodiment.

As in the first embodiment, the mobile terminal 100 includes a display unit 102 that displays the target item value.

Other configurations of the second embodiment are the same as those of the first embodiment.

In the present embodiment, as described above, the mobile terminal 100 includes the acquisition unit 111, identification unit 112, detection unit 113, determination unit 114, and the display unit 102 as an output unit. In other words, in this embodiment, the mobile terminal 100 functions as the information processing device of the present invention. Accordingly, the mobile terminal 100 can detect the color of teeth and determine the target item value without communicating with the server 200.

Other effects of the second embodiment are the same as those of the first embodiment.

Next, with reference to FIG. 12, the processing flow of the mobile terminal 100 in the second embodiment will be described. FIG. 12 is a flowchart showing the processing flow of the mobile terminal 100 in the second embodiment. In this embodiment, the processing flow includes steps S101, S102, S301 to S304, and S105. These steps are executed by the control unit 110.

As shown in FIG. 12, steps S101 and S102 are executed in the same manner as in the first embodiment.

Next, in step S301, the control unit 110 acquires image data. Specifically, the acquisition unit 111 acquires the image data from the imaging unit 101.

Next, in step S302, the control unit 110 identifies the tooth region I50a in the image I50. Specifically, the identification unit 112 distinguishes between the tooth region I50a and the non-tooth regions in the image I50. In this embodiment, the identification unit 112 inputs the image data into a trained model to obtain data indicating the tooth region I50a and the non-tooth regions.

Next, in step S303, the control unit 110 detects a target color value representing the color of the tooth region I50a. Specifically, the detection unit 113 detects the target color value representing the color of the target region I50b within the tooth region I50a.

Next, in step S304, the control unit 110 determines the target item value. In this embodiment, the target item value is the tooth age. Specifically, the determination unit 114 determines the tooth age based on the target color value detected by the detection unit 113 and the associated data D1.

Next, in step S105, the control unit 110 displays a predetermined image on the display unit 102. Specifically, the control unit 110 displays the image I53 indicating the tooth age, based on the information determined by the determination unit 114.

In this manner, the processing of the mobile terminal 100 in the second embodiment is completed.

In the second embodiment, the target region I50b may be a region excluding decayed and prosthetic portions. That is, the detection unit 113 may detect the color value of a region excluding decayed and prosthetic areas. In this case, the detection unit 113 may set the region within the tooth region I50a, excluding the decayed and prosthetic areas, as the target region I50b. Alternatively, the identification unit 112 may identify the tooth region I50a excluding the decayed and prosthetic portions.

### (Second Modification)

The mobile terminal 100 of a second modification of the second embodiment of the present invention will be described. In this modification, unlike the second embodiment, the target item value includes a shade guide identification number.

As shown in FIG. 9, in the second modification, the reference item value in the associated data D2 is, for example, a shade guide identification number, similar to the first modification.

The determination unit 114 selects the reference color value closest to the target color value detected by the detection unit 113, based on the associated data D2. As in the second embodiment, the determination unit 114 selects the reference color value closest to the converted Lab* value from the associated data D2. In the second modification, the determination unit 114 selects the shade guide identification number (reference item value) corresponding to the selected Lab* value (reference color value) from the associated data D2. In other words, the determination unit 114 determines the shade guide identification number corresponding to the selected reference color value.

Other configurations and effects of the second modification are the same as those of the first modification and the second embodiment.

Next, with reference to FIG. 12, the processing flow of the mobile terminal 100 in the second modification will be described.

As shown in FIG. 12, in step S101, the control unit 110 determines whether a user (e.g., a dentist) has performed an input operation. Specifically, the display unit 102 displays a button to start selecting the shade guide identification number closest to the color of the patient's teeth. When the user wishes to start the selection, they touch the start button. Then, while pointing the camera lens toward the subject (the patient), the user touches the shutter button displayed on the display unit 102. Accordingly, the control unit 110 determines that user input has been received.

Next, steps S102 and S301 to S303 are executed in the same manner as in the second embodiment.

In step S304, the control unit 110 determines the target item value. In the second modification, the target item value is the shade guide identification number. Specifically, the determination unit 114 determines the shade guide identification number based on the target color value detected by the detection unit 113 and the associated data D2.

Next, in step S105, the control unit 110 causes the display unit 102 to display a predetermined image. Specifically, as shown in FIG. 10, the control unit 110 causes the display unit 102 to display the image I54 indicating the determined shade guide identification number.

Other parts of the processing flow of the mobile terminal 100 in the second modification are the same as in the first modification and the second embodiment.

### Third Embodiment

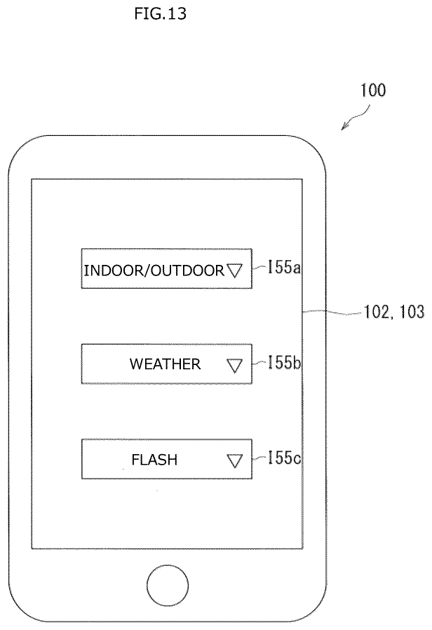

With reference to FIG. 13 and other drawings, a third embodiment of the information processing system 1000 according to the present invention will be described. FIG. 13 is a diagram showing an example of an image displayed on the display unit 102 of the mobile terminal 100 in the third embodiment. When detecting a target color value based on a captured image, the color in the image may vary depending on brightness conditions such as the surrounding environment during image capture. This may lead to reduced accuracy in detecting the target color value. Therefore, unlike the first embodiment, the first modification, the second embodiment, and the second modification, the third embodiment describes a case in which the target item value is determined based on brightness information at the time of image capture. Note that in this embodiment, “brightness” includes at least lightness. In this embodiment, brightness includes both lightness and saturation. It may also include the intensity of ambient light, or both the intensity and wavelength of ambient light.

Although this embodiment is described as a variation of the first embodiment, it is also applicable to the first modification, second embodiment, and second modification.

The acquisition unit 211 acquires brightness information indicating the brightness at the time of capturing the image of the teeth. In this embodiment, the acquisition unit 211 acquires the brightness information from the mobile terminal 100. Specifically, the display unit 102 of the mobile terminal 100 displays an image for inputting the brightness information during tooth imaging. The brightness information includes at least one of (a) Information indicating whether the imaging location is indoors or outdoors, (b) Information indicating the current weather, and (c) Information indicating whether a flashlight is used during imaging.

As shown in FIG. 13, the display unit 102 displays, for example, an image I55a indicating whether the imaging location is indoors or outdoors. The display unit 102 also displays an image I55b indicating the current weather, and an image I55c indicating whether a flashlight is used during imaging. In this embodiment, the images I55a, I55b, and I55c are implemented as dropdown menus. The user can input brightness information by operating the dropdown menus. Note that instead of dropdown menus, input fields or selection items for brightness information may also be displayed on the display unit 102.

When the user operates the dropdown menus to input brightness information, the input unit 103 receives the input, and the communication unit 104 transmits the brightness information to the server 200.

In this embodiment, the acquisition unit 211 acquires both the image data and the brightness information from the mobile terminal 100.

In this embodiment, the determination unit 214 determines the target item value based on the brightness information, the target color value, and the associated data. The associated data, in this embodiment, includes data in which the brightness information, reference color values, and reference item values are associated. Specifically, for example, associated data D1 such as that shown in FIG. 5 may be provided for each combination of brightness information. That is, associated data D1 may be prepared for each set of brightness conditions. Alternatively, the associated data may include a formula that adjusts reference color values based on the brightness information in addition to the associated data D1.

As described above, the determination unit 214 determines the target item value based on the brightness information, target color value, and associated data D1. Therefore, it is possible to suppress degradation in detection accuracy of the target item value due to variations in brightness during image capture.

Note that the image data may be brightness-corrected based on the brightness information, and the target color value may be detected based on the corrected image data. The target item value may then be determined based on the detected target color value and the associated data D1. Such a case is also included in the scenario where the determination unit 214 determines the target item value based on brightness information, the target color value, and the associated data D1.

Other configurations, processing flows, and effects of the third embodiment are the same as those of the first embodiment, the first modification, the second embodiment, and the second modification.

### Fourth Embodiment

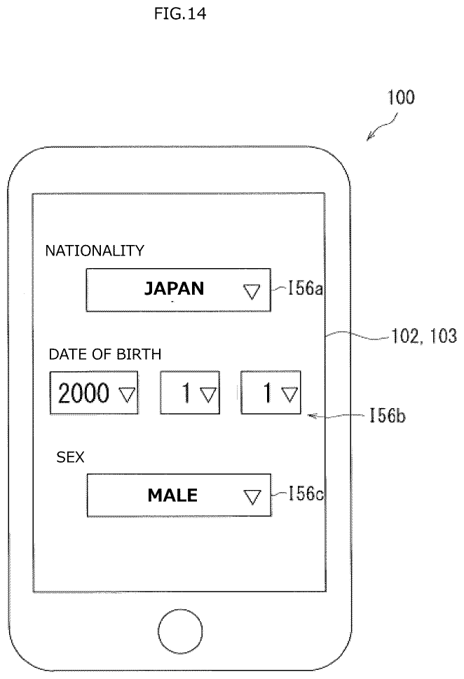

With reference to FIG. 14 and other drawings, a fourth embodiment of the information processing system 1000 according to the present invention will be described. FIG. 14 is a diagram showing an example of an image displayed on the display unit 102 of the mobile terminal 100 in the fourth embodiment. Unlike the first embodiment, the first modification, the second embodiment, the second modification, and the third embodiment, the fourth embodiment describes a case in which the target item value is determined based on the personal information of the subject (target person). Although this embodiment is described as a variation of the first embodiment, it is also applicable to the first modification, second embodiment, second modification, and third embodiment.

The acquisition unit 211 acquires personal information of the subject (target person). In this embodiment, the acquisition unit 211 acquires the personal information from the mobile terminal 100. Specifically, the display unit 102 of the mobile terminal 100 displays an image for inputting personal information. The personal information includes at least one of (a) Information indicating nationality or ethnicity, (b) Information indicating date of birth or actual age, and (c) Information indicating gender. The personal information may also include DNA data, medical history, or information recorded in a medical chart (clinical record).

As shown in FIG. 14, the display unit 102 displays, for example, an image I56a containing information indicating nationality or ethnicity. It also displays an image I56b indicating date of birth or actual age, and an image I56c indicating gender. In this embodiment, the images I56a, I56b, and I56c are implemented as dropdown menus. The user can input personal information by operating the dropdown menus. Note that, in addition to dropdown menus, input fields or selection items for entering personal information may be displayed on the display unit 102.

When the user inputs personal information using the dropdown menus, the input unit 103 accepts the operation, and the communication unit 104 transmits the personal information to the server 200.

In this embodiment, the acquisition unit 211 acquires both the image data and the personal information from the mobile terminal 100.

In this embodiment, the determination unit 214 determines the target item value based on the personal information, the target color value, and the associated data. Here, the associated data includes data in which the personal information, reference color values, and reference item values are associated. For example, associated data D1, such as that shown in FIG. 5, may be provided for each combination of personal information. That is, associated data D1 may be prepared for each personal information profile. Alternatively, the associated data may include a formula for adjusting reference color values based on the personal information, along with the associated data D1.

Specifically, for example, tooth color differs depending on nationality or race. For instance, in the case of Japanese individuals or people of East Asian descent, tooth color tends to have a yellowish tone. Accordingly, by determining the target item value based on at least one of nationality information and racial information, as in the present embodiment, it becomes possible to determine the tooth age more accurately.

Further, in the present embodiment, when the target item value is determined based on date of birth or actual age as personal information, the determination may be performed in a manner that prevents the difference between the tooth age and actual age from becoming too large. For example, if the actual age is 30 but the selected tooth age is 70, the determined tooth age may be set to an intermediate value (e.g., 50). This configuration allows suppression of excessive discrepancies between actual age and tooth age, such as when the captured image quality is temporarily degraded.

The target item value may be determined based on both nationality and racial information (at least one), and age information. Alternatively, it may be determined based on only one of them. By determining the target item value based on the target color value, associated data D1, at least one of nationality and racial information, and age information, even more accurate determination of tooth age becomes possible.

Additionally, the target item value may also be determined based on gender, as part of the personal information. In such a case, the determination of tooth age can be made even more accurately.

In the present embodiment, as described above, the determination unit 214 determines the target item value based on the target color value, the associated data D1, and at least one of nationality and racial information. Accordingly, a more accurate tooth age can be determined.

Moreover, as described above, the determination unit 214 may determine the target item value based on the target color value, the associated data D1, and age information. This allows suppression of discrepancies between actual age and tooth age.

Other configurations, processing flows, and effects of the fourth embodiment are the same as those in the first embodiment, first modification, second embodiment, second modification, and third embodiment.

### Fifth Embodiment

An information processing system 1000 according to a fifth embodiment of the present invention will be described. In this embodiment, unlike the first through fourth embodiments, the case is described in which tooth age is determined based on the area of the tooth region I50a. While the fifth embodiment is described as a variation of the first embodiment, it may also be applied to the second through fourth embodiments.

The identification unit 212 identifies the tooth region I50a within the image I50. In this embodiment, the tooth region I50a excludes decayed areas. That is, the identification unit 212 identifies the region excluding decayed areas as the tooth region I50a. The tooth region I50a may also exclude both decayed and prosthetic areas.

Specifically, decayed areas are typically brownish or blackish in color, and prosthetic areas are typically silver-colored. The identification unit 212 performs color-based classification on a per-pixel basis to identify the tooth region I50a. The criteria for color judgment may be set based on the color values of a shade guide. Alternatively, the identification unit 212 may use a trained model to identify the tooth region I50a that excludes decayed and/or prosthetic portions.

In this embodiment, the determination unit 214 determines the tooth age based on the area of the tooth region I50a. Specifically, if the area of the tooth region I50a is smaller than a reference area, the determination unit 214 adds a predetermined number of years to the tooth age indicated by the associated data D1 shown in FIG. 5. For example, if the calculated tooth age based on the target color value and associated data D1 is 50 years, and the area of the tooth region I50a is 80% or less of the reference area, the tooth age may be set to 60 years. The threshold value is not particularly limited, and may include one of 90%, 80%, 70%, 60%, or 50%. Multiple threshold values may be defined, with a specific number of added years set for each. Alternatively, without defining threshold values, the added number of years may be calculated using a formula based on the ratio of the actual area of the tooth region I50a to the reference area. The method for calculating the area is described below.

The determination unit 214 may calculate the area of the tooth region I50a, or alternatively, the control unit 210 may include an area calculation unit for calculating the area of the tooth region I50a.

The tooth region I50a may be a region covering multiple teeth (e.g., all teeth in the image I50), or it may correspond to one or two specific teeth, or to each individual tooth.

Next, the method for calculating the area of the tooth region I50a will be described.

Generally, the position of a tooth correlates with its size. For example, the central incisors (tooth number 1), which are located front and center, tend to be the largest in area. The ratio of the area of each tooth to that of the central incisor is relatively fixed. The storage unit 220 stores, for example, standard area values and area ratios of each tooth relative to the central incisor as reference values. Therefore, by detecting the area of the central incisor in image I50 and comparing it with the area of a particular tooth region I50a in the same image, the area of tooth region I50a can be easily calculated. The storage unit 220 may store either the general tooth area values or only the area ratios as reference values.

In this embodiment, as described above, the determination unit 214 determines the tooth age based on the area of the tooth region I50a. Accordingly, for example, a high tooth age may be indicated for patients with many decayed teeth, which can encourage those patients to seek treatment. This contributes to an increase in both the number of patients and revenue at dental clinics.

Although this embodiment describes area reduction due to decayed or prosthetic portions, the invention is not limited thereto. For instance, even in the absence of such portions, area reduction may occur due to misaligned teeth, chipped tooth tips, or partially broken teeth. In such cases, the area of the tooth in image I50 becomes smaller, which results in a higher tooth age. Therefore, patients with such conditions may also be motivated to seek dental treatment, contributing to an increase in clinic visits and sales.

Other configurations, processing flows, and effects of the fifth embodiment are the same as those of the first through fourth embodiments.

Note that in the fifth embodiment, an example is described in which the same tooth area results in the same tooth age. However, the present invention is not limited to this. For instance, even when the area of the tooth region I50a is the same, the tooth age may be varied depending on the cause of the area reduction. Below, an example is provided in which the same area leads to different tooth ages depending on whether the reduction is due to decay, misalignment, or chipping.

For example, if the tooth region I50a is 90% of the reference area and the reduction is due to decay, the number of added years may be 5. If the reduction is due to misalignment, the added years may be 3. If the reduction is due to chipping of the tooth tip, the added years may be 1. By adjusting the added years based on the cause of the area reduction, it becomes possible to appropriately determine the tooth age in accordance with the condition of the teeth.

In the method of the fifth embodiment, for example, if the area of the reference tooth (central incisor, tooth number 1) is reduced, calculating the areas of other teeth based on this reference may result in significant deviations from the standard tooth areas. Specifically, when the tip of the central incisor is worn down, the calculated areas of other teeth may deviate substantially from the standard areas.

To address this, for example, the area of the central incisor may be corrected such that, when its ratio to the area of another tooth is smaller than a generally expected ratio, the ratio becomes aligned with the typical ratio.

Alternatively, if the ratio of the vertical length to the horizontal length of the central incisor is smaller than the generally expected ratio, the vertical length may be corrected so that the ratio matches the typical value. In other words, the area of the central incisor may be corrected.

With such a configuration, even if the tip of the reference tooth (central incisor) is worn and the length is shorter than the ideal, it is possible to prevent the areas of the other teeth from significantly deviating from their respective standard areas.

### Sixth Embodiment

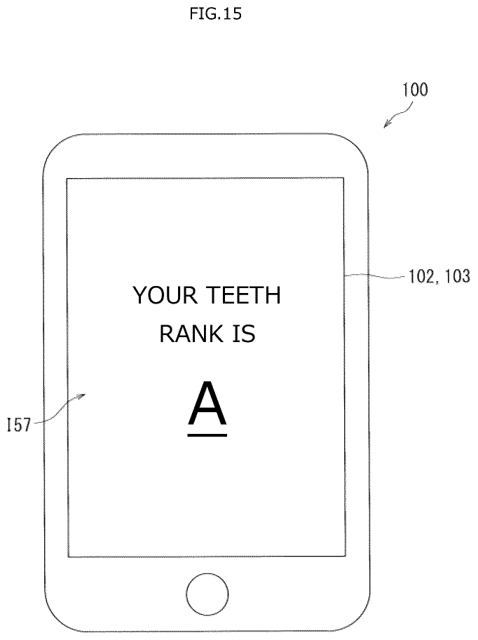

The sixth embodiment of the information processing system 1000 according to the present invention will be described with reference to FIG. 15 and other drawings. FIG. 15 is an example of an image I57 displayed on the display unit 102 of the mobile terminal 100 in the sixth embodiment. Unlike the first through fifth embodiments and the first and second modifications, the sixth embodiment describes a case where the target item value includes an evaluation value. While this embodiment is explained as a modification of the first embodiment, it can also be applied to the second through fifth embodiments.

In the sixth embodiment, the reference item value in the associated data includes an evaluation value. The target item value also includes an evaluation value of the tooth region I50a. In this embodiment, the evaluation value indicates a quality or score for the teeth. Although not limited thereto, the evaluation value may be a numerical value between 0 and 100, or may be expressed in letters, words, numbers, alphabets, or symbols representing ranks, grades, and/or classes (hereinafter collectively referred to as “rank, etc.”). In this embodiment, the evaluation values for both the reference item and target item are expressed as alphabetical ranks.

The determination unit 214 selects from the associated data the reference color value closest to the target color value detected by the detection unit 213. In this embodiment, the determination unit 214 selects the alphabet corresponding to the selected reference color value from the associated data D1, such as that shown in FIG. 5. In other words, the determination unit 214 determines the alphabet corresponding to the selected reference color value.

In the processing flow of the mobile terminal 100, at step S104 (as shown in FIG. 6), the control unit 110 receives information indicating an alphabet representing the rank. Specifically, the control unit 110 receives, via the communication unit 104, information on the rank-representing alphabet from the server 200.

Next, in step S105, as shown in FIG. 15, the control unit 110 displays, on the display unit 102, an image I57 indicating the alphabet based on the received rank information.

Other configurations and processing flows of the mobile terminal 100 in the sixth embodiment are the same as those of the first through fifth embodiments.

In the processing flow of the server 200 in this embodiment, at step S204 (as shown in FIG. 8), the determination unit 214 determines the alphabet representing the rank based on the target color value detected by the detection unit 213 and the associated data D1.

Next, in step S205, the control unit 210 transmits the determined alphabet information to the mobile terminal 100 via the communication unit 201.

In the sixth embodiment, as described above, the reference item value includes an evaluation value, and the target item value includes an evaluation value of the tooth region I50a. Therefore, for example, it is possible to evaluate a patient's teeth based on their color.

Other configurations and processing flows of the server 200 in the sixth embodiment are the same as those of the first through fifth embodiments.

### Seventh Embodiment

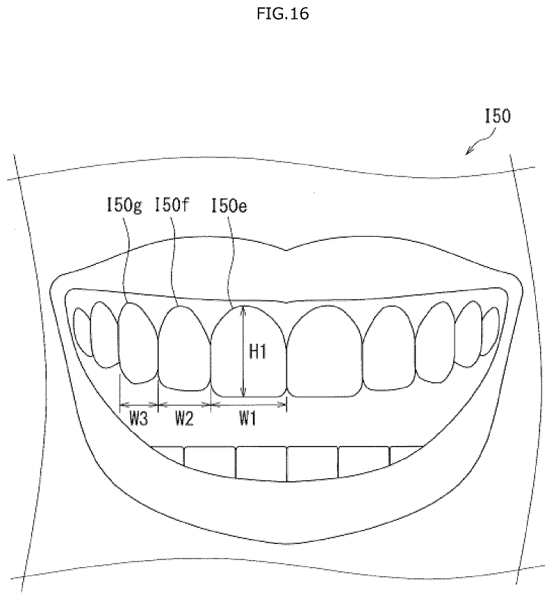

The seventh embodiment of the information processing system 1000 according to the present invention will be described with reference to FIG. 16 and other drawings. FIG. 16 is an enlarged partial view of an example of the image I50 in the seventh embodiment. Unlike the first through sixth embodiments, the seventh embodiment describes a case in which the target item value is determined based on the ratio of tooth widths in addition to tooth color. While this embodiment is explained as a modification of the first embodiment, it can also be applied to the second through sixth embodiments.

The identification unit 212 identifies the tooth region I50a within the image I50. In this embodiment, the tooth region I50a includes at least one maxillary central incisor region I50e and one maxillary lateral incisor region I50f. Preferably, the tooth region I50a includes one maxillary central incisor region I50e, one maxillary lateral incisor region I50f, and one maxillary canine region I50g. The tooth region I50a may also include two maxillary central incisors, two maxillary lateral incisors, and two maxillary canines. It may further include mandibular central and lateral incisors and mandibular canines.

The determination unit 214 determines the target item value based on the ratio between the width W1 of the maxillary central incisor region I50e and the width W2 of the maxillary lateral incisor region I50f. In this embodiment, the determination unit 214 determines the target item value based on the ratios of width W1 (central incisor), W2 (lateral incisor), and W3 (canine).

Specifically, the determination unit 214 calculates the ratio between the width W1 of the maxillary central incisor region I50e and the width W2 of the maxillary lateral incisor region I50f, based on these two regions. In this embodiment, the determination unit 214 calculates the ratio of the width W1 of the maxillary central incisor region I50e, the width W2 of the maxillary lateral incisor region I50f, and the width W3 of the maxillary canine region I50g (hereinafter sometimes referred to as the “anterior tooth ratio”) based on the regions I50e, I50f, and I50g. At this time, it is preferable for the determination unit 214 to normalize the width of the maxillary lateral incisor region I50f to “1.” Note that the ratio calculation does not necessarily have to be performed by the determination unit 214; alternatively, the control unit 210 may include a ratio calculation unit for computing the ratios.

Then, the determination unit 214 determines the target item value based on the target color value, the associated data D1, the calculated ratio, and either the golden ratio or silver ratio. Teeth aligned according to these ratios are not only aesthetically pleasing but are also less likely to develop cavities due to proper alignment. The golden ratio is 1.618:1:0.618, and the silver ratio is 1.414:1:0.707. For simplicity, approximate values like 1.6:1:0.6 or 1.4:1:0.7 may also be used. In this embodiment, the target item value is corrected based on the deviation between the calculated ratio and the golden or silver ratio. Alternatively, associated data linking the reference color value, reference item value, and the golden or silver ratio may be used.

Specifically, if the difference between the calculated ratio and the golden or silver ratio exceeds a first threshold, the determination unit 214 increases the tooth age calculated using the associated data D1 by a predetermined number of years. For example, if the tooth age calculated from the target color value and associated data D1 is 50, and the ratio deviation exceeds the first threshold, the tooth age may be corrected to 55. Multiple thresholds may be set, and different numbers of years may be added for each threshold.

Further, when the difference between the calculated ratio and the golden ratio or silver ratio is equal to or less than a second threshold that is smaller than a first threshold, the determination unit 214 may determine the tooth age by subtracting a predetermined number of years from the tooth age calculated based on the associated data D1 shown in FIG. 5. For example, even if the tooth age based on the target color value and the associated data D1 is 50 years, the determination unit 214 may set the tooth age to 45 years if the difference from the golden or silver ratio is equal to or less than the second threshold.

Note that instead of calculating the difference between the calculated ratio (anterior tooth ratio) and the golden or silver ratio, the number of years to be added or subtracted may be computed using a formula based on the calculated ratio (anterior tooth ratio).

In the seventh embodiment, as described above, the target item value (in this case, tooth age) is determined based not only on tooth color but also on the ratio of tooth widths. With this configuration, for example, in cases of misaligned teeth, the difference between the anterior tooth ratio and the golden or silver ratio becomes large, resulting in a higher tooth age. Accordingly, it becomes possible to expect a certain number of patients who seek dental treatment, thereby contributing to an increase in both the number of patients and revenue for dental clinics.

Other configurations, processing flows, and effects of the seventh embodiment are the same as those of the first through sixth embodiments.

Note that although the seventh embodiment describes an example where tooth age is used as the target item value, the present invention is not limited thereto. For example, a value other than tooth age may be used as the target item value.

### Eighth Embodiment

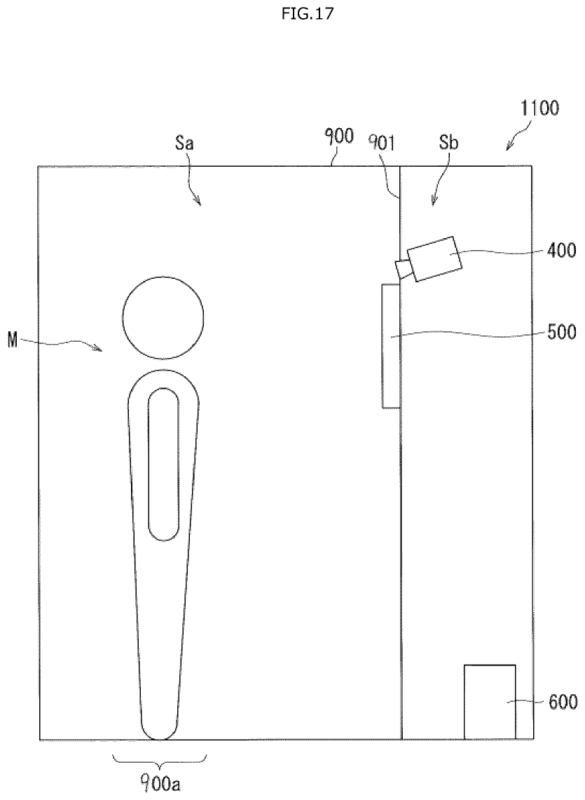

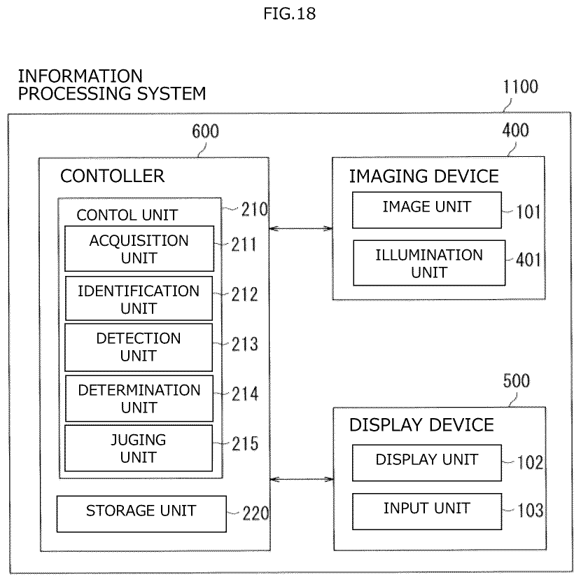

The eighth embodiment of the information processing system 1100 according to the present invention will be described with reference to FIGS. 17 through 19 and other drawings. FIG. 17 is a side view schematically showing the information processing system 1100 of the eighth embodiment. FIG. 18 is a block diagram showing the configuration of the information processing system 1100. Unlike the first through seventh embodiments, the eighth embodiment describes an example in which it is determined whether or not the subject person is facing forward.

As shown in FIG. 17, the information processing system 1100 of this embodiment includes a housing 900, an imaging device 400, a display device 500, and a control device 600. The information processing system 1100 is an example of the “information processing device” according to the present invention.

The housing 900 has a box-like shape for accommodating a subject person M. The housing 900 includes an imaging position 900a, which is the position where the person M stands or sits during imaging. A mark indicating the position where the person M should stand may be printed at the imaging position 900a. Alternatively, a chair (not shown) on which the person M sits may be provided at the imaging position 900a.

The housing 900 includes a partition wall 901 that divides the internal space into a space Sa for accommodating the person M and a space Sb for accommodating the imaging device 400 and control device 600. Note that the internal space of the housing 900 may not necessarily be divided into the space Sa and the space Sb.

As shown in FIG. 18, the imaging device 400 includes an imaging unit 101 and an illumination unit 401. The illumination unit 401 illuminates the person M. The illumination unit 401 is not particularly limited, and may include, for example, an LED and a reflector that reflects light emitted from the LED in a predetermined direction.

The display device 500 includes a display unit 102 and an input unit 103. The display unit 102 and the input unit 103 together form a touch display. For example, the display unit 102 displays an image captured by the imaging unit 101. The display unit 102 may also display contour markers indicating the outline of the face and/or mouth at predetermined positions on the screen. This allows the person M to adjust the position of their face and/or mouth such that it fits within the contour markers. As a result, the face and/or mouth of the person M and the imaging device 400 are positioned in a predetermined spatial relationship, facilitating recognition of the face and/or mouth by the control device 600.

The control device 600 includes a control unit 210 and a storage unit 220. The control device 600 is connected to the imaging device 400 and the display device 500 via cables and controls both devices. In this embodiment, the control device 600 is described as being installed inside the housing 900, but it may alternatively be a server located outside the housing 900.

As in the first embodiment, the control unit 210 includes an acquisition unit 211, an identification unit 212, a detection unit 213, and a determination unit 214.

In this embodiment, the control unit 210 further includes a judgment unit 215. The judgment unit 215 determines whether the person M in the image is facing forward. In other words, the judgment unit 215 determines whether the facial image of person M included in the image I50 is a front-facing image.

Specifically, the identification unit 212 identifies at least a part of the region within the image I50 captured of person M. In this embodiment, the identification unit 212 identifies, for example, a landmark region indicating landmarks such as the facial outline, lips, nose, chin, and/or eyes.

The judgment unit 215 determines the orientation of the face of person M in image I50 based on the landmark region identified by the identification unit 212. For example, the judgment unit 215 may determine the face orientation using a trained model. Alternatively, the judgment unit 215 may determine the orientation based on the shape of the landmark region and/or differences in size due to perspective.

Then, the judgment unit 215 determines whether person M in the image I50 is facing forward based on the facial orientation. That is, it determines whether the face of person M is directed toward the imaging unit 101. For example, if the deviation angle of person M's face relative to the imaging unit 101 is within a predetermined range, the judgment unit 215 determines that person M is facing forward. The predetermined angle may be 20°, 10°, 5°, or 3°, for example.

The determination unit 214 uses, as the image I50 for calculating the target item value, the image I50 in which person M is determined to be facing forward. Accordingly, the identification unit 212 identifies the tooth region I50a from the image I50 where person M is determined to be facing forward.

In this case, the judgment unit 215 may also determine whether the image I50 includes a tooth region I50a in addition to person M facing forward, and the determination unit 214 may use the image I50, where both conditions are met, as the image for calculating the target item value. Whether the tooth region I50a is present may be determined based on whether it is located at a predetermined position relative to the edge of the image I50 or the facial outline.

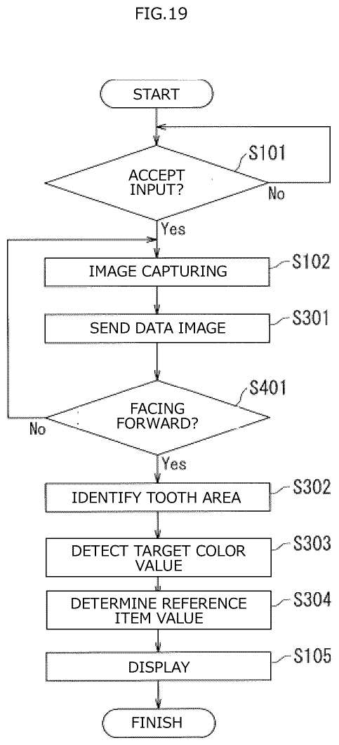

Next, the processing flow of the information processing system 1100 of the eighth embodiment will be described with reference to FIG. 19. FIG. 19 is a flowchart illustrating the processing flow of the information processing system 1100 of the eighth embodiment.

As shown in FIG. 19, steps S101, S102, and S301 are executed in the same manner as in the second embodiment.

Next, in step S401, the control unit 210 determines whether person M is facing forward. Specifically, the judgment unit 215 determines whether the face of person M in the image I50 is facing forward.

If the judgment unit 215 determines in step S401 that person M is not facing forward, the process returns to step S102.

On the other hand, if the judgment unit 215 determines in step S401 that person M is facing forward, the determination unit 214 decides to use the image I50 in which person M is facing forward for the subsequent processing from step S302. At this time, since the image I50 for calculating the target item value has been determined, the information processing system 1100 may produce a shutter sound, for example. In this case, the information processing system 1100 may include a speaker, or the imaging device 400 or display device 500 may include one. The process then proceeds to step S302.

Note that in step S401, the judgment unit 215 may determine whether both conditions are met, person M is facing forward and the image includes a tooth region I50a.

Next, steps S302 to S304 and S105 are executed in the same manner as in the second embodiment.

In this way, the processing of the information processing system 1100 of the eighth embodiment is completed.

In the eighth embodiment, as described above, the system determines whether person M in the image I50 is facing forward. Therefore, it is possible to suppress a decrease in the accuracy of identifying the tooth region I50a by the identification unit 212.

In cases where the target item value is determined based on the ratio of tooth widths as in the seventh embodiment, determining whether person M in the image I50 is facing forward, as in the eighth embodiment, is particularly effective. Specifically, when person M is facing forward in image I50, the ratio of tooth widths can be accurately calculated, thereby enabling accurate determination of target item values such as tooth age and evaluation values.

Additionally, as described above, the judgment unit 215 determines whether person M in the image I50 is facing forward, and the identification unit 212 identifies the tooth region I50a in the image I50 where person M is determined to be facing forward. Therefore, person M or another user does not need to manually operate the shutter button or the input unit 103 at the appropriate timing.

The other configurations and effects of the eighth embodiment are similar to those of the first through seventh embodiments and the first and second modifications described above.

The embodiments and modifications of the present invention have been described above with reference to the drawings. However, the present invention is not limited to the embodiments and modifications described above, and may be implemented in various other forms without departing from the spirit of the invention. In addition, the multiple components disclosed in the above embodiments and modifications may be appropriately modified. For example, some components shown in one embodiment may be added to another embodiment or modification, or some components may be removed from one embodiment or modification.

In the drawings, each component is schematically illustrated primarily for ease of understanding the invention, and the thickness, length, quantity, spacing, etc., of each illustrated component may differ from actual measurements for drafting convenience. Moreover, the structures of each component described in the embodiments above are merely examples, and various changes can be made without materially departing from the effects of the present invention.

For example, while the embodiments above describe a case in which the information processing device is used by a dentist at a dental clinic, the invention is not limited thereto. For instance, general users may use the device at home or elsewhere.

Also, in the third embodiment, an example is provided where the user inputs brightness information. However, the invention is not limited to this. For example, the mobile terminal 100 may automatically acquire brightness information. This configuration further reduces the complexity of the user's operations.

Specifically, the mobile terminal 100 may include a light sensor that detects the ambient brightness. The light sensor may send the detected brightness information to the control unit 110. Additionally, the control unit 110 may determine whether a flashlight was used during imaging and acquire brightness information accordingly. The mobile terminal 100 may also include a GPS (Global Positioning System) receiver to obtain location information, and then determine whether the imaging location is indoors or outdoors based on location and map information retrieved via a communication network 300. Furthermore, the mobile terminal 100 may acquire weather information through the communication network based on location information and determine the current weather at the imaging location.

As described above, brightness includes both lightness and saturation. Therefore, for example, if teeth are imaged during a sunset, they may appear reddish. However, the light sensor may detect red-toned light, and based on this detection, the target item value can be determined accordingly. Thus, more accurate determination of tooth age becomes possible.

In the third embodiment, examples of brightness information include whether the imaging location is indoors or outdoors, the current weather, and whether a flashlight is used. However, the invention is not limited to these. For instance, brightness information may also include the current time.

Additionally, in the fourth embodiment, an example is shown where the user inputs the subject's personal information. However, the invention is not limited to this. For example, when the mobile terminal 100 is used in a dental clinic, the user may input the patient's name and/or ID using the input unit 103, allowing the mobile terminal 100 to retrieve the patient's personal information from the clinic's patient information management system. This system may store and associate information such as name, sex, address, date of birth, actual age, and medical history.

In the fifth embodiment, an example is given where tooth age is determined based on the area of the tooth region I50a. However, the invention is not limited to this. For example, tooth age may also be determined based on tooth volume. If the imaging unit 101 includes a 3D scanner, the volume of the tooth can be calculated from the 3D scanned image, and tooth age may be determined based on that volume.

Additionally, in the fifth embodiment, an example is described in which the imaging unit 101 captures a frontal image of the subject to calculate the area (frontal area) of the tooth. However, the invention is not limited to this. For instance, a 3D scanner or panoramic X-ray imaging device may be used to capture the subject from an angle other than the front, and the area (surface area or lateral area) of the tooth may be calculated based on such an image.

In the seventh embodiment, an example is described in which the target item value is determined based on the ratio between the width W1 of the upper central incisor region I50e, the width W2 of the upper lateral incisor region I50f, and the width W3 of the upper canine region I50g. However, the invention is not limited to this. For example, the target item value may be determined based on the ratio between the height HI and width W1 of the upper central incisor region I50e. In this case, if the difference between the calculated ratio and a predetermined ratio exceeds a third threshold value, the determination unit 214 may determine a tooth age by adding a predetermined number of years to the tooth age in the related data D1 shown in FIG. 5. For example, a predetermined ratio of 1:0.8 may be used.

Also, in the seventh embodiment, the tooth age is used as the target item value, but the invention is not limited to this. For example, as in the sixth embodiment, an evaluation value may be used as the tooth age. In this case, rather than adding or subtracting years to/from the tooth age, the rank, grade, or class may be upgraded or downgraded.

In the eighth embodiment, an example is described in which an information processing system 1100 equipped with a housing 900 determines whether person M is facing forward. However, the invention is not limited to this. For example, in cases where the mobile terminal 100 is used to capture images of person M, as in the first embodiment, the system may also determine whether person M is facing forward.

In the first embodiment, the detection unit 213 detects color values at multiple locations within the target region I50b and averages them to obtain a target color value representing the color of the region. However, the invention is not limited to this. For instance, the detection unit 213 may detect multiple color values within the target region I50b as individual target color values, and the determination unit 214 may determine a separate target item value for each. For example, in the first modification, the detection unit 213 may detect color values at multiple locations as target color values, and the determination unit 214 may determine a shade guide identification number for each location.

It should be noted that, for example, in the fifth embodiment or the seventh embodiment, the area or ratio may also be calculated based on an image captured using an X-ray imaging device as the imaging unit 101.

### INDUSTRIAL APPLICABILITY

The present invention is useful in the field of detecting the color of teeth.

### REFERENCE SIGNS LIST

100: Mobile terminal (information processing device)
101: Imaging unit
102: Display unit (output unit)
111, 211: Acquisition unit
112, 212: Identification unit
113, 213: Detection unit
114, 214: Determination unit
120, 220: Storage unit
200: Server (information processing device)
201: Communication unit (output unit)
215: Judgment unit
1100: Information processing system (information processing device)
D1, D2: Associated data
150: Image
I50a: Tooth region
I50e: Upper central incisor region
I50f: Upper lateral incisor region
I50g: Upper canine region
M: Person
W1, W2, W3: Width

1. An information processing device comprising a processor and a memory that stores associated data in which a reference color value and a reference item value are associated, the processor being configured to:
acquire first image data representing an image capturing a tooth;
identify a region of the tooth within the image;
detect a target color value indicating color of the tooth region;
determine a target item value based on the target color value and the associated data; and
output the target item value,
wherein the processor is configured to detect color values at a plurality of points within the identified tooth region and set an average of the color values at the plurality of points as the target color value.

2. The information processing device according to claim 1, wherein the reference item value includes a tooth age, and
the target item value includes the tooth age of the tooth region.

3. The information processing device according to claim 1, wherein the reference item value includes an identification number of a shade guide, and
the target item value includes the identification number of the shade guide corresponding to the tooth region.

4. The information processing device according to claim 1, wherein the reference item value includes an evaluation value, and
the target item value includes the evaluation value of the tooth region.

5. The information processing device according to claim 1, wherein the processor acquires brightness information relating to brightness at a time of imaging the tooth, and
determines the target item value based on the brightness information, the target color value, and the associated data.

6. The information processing device according to claim 1, wherein the processor acquires at least one of nationality information and race information of a person to be imaged,
the associated data associates the reference color value and the reference item value with at least one of the nationality information and the race information, and
the processor determines the target item value based on the target color value, the associated data, and at least one of the nationality information and the race information.

7. The information processing device according to claim 1, wherein the processor acquires age information of a person to be imaged,
the associated data associates the reference color value and the reference item value with the age information, and
the processor determines the target item value based on the target color value, the associated data, and the age information.

8. The information processing device according to claim 2, wherein the processor determines the target item value based on an area or volume of the tooth region.

9. The information processing device according to claim 2, wherein the processor identifies a region of an upper central incisor and a region of an upper lateral incisor within the image, and
determines the target item value based on a ratio between a width of the upper central incisor region and a width of the upper lateral incisor region.

10. The information processing device according to claim 1, wherein the processor is further configured to determine whether a person in the image is facing forward, and
the processor identifies the tooth region from the image that is determined to include the person facing forward.

11. The information processing device according to claim 1, further comprising a display and a camera that captures the image of the tooth,
wherein the display displays the target item value.

12. A non-transitory computer-readable storage medium storing instructions which, when executed, cause a processor to:
acquire image data representing an image capturing a tooth;
identify a region of the tooth within the image;
detect a target color value indicating color of the tooth region;
determine a target item value based on the target color value and associated data in which a reference color value and a reference item value are associated; and
output the target item value,
wherein the instructions cause the processor to detect color values at a plurality of points within the identified tooth region and to set an average of the color values at the plurality of points as the target color value.

13. The information processing device according to claim 1, wherein the processor is configured to:
acquire second image data indicating a surface temperature and/or blood flow of the tooth, and/or third image data captured by a CT or X-ray imaging device, and
identify the tooth region based on the second or third image data, or based on a boundary between a whitish region and a reddish or pinkish region in the first image data.

14. An information processing system comprising:
a mobile terminal that captures an image of a tooth; and
a server that receives the image from the mobile terminal,
wherein the server comprises a processor and a memory that stores associated data in which a reference color value and a reference item value are associated, and
the processor is configured to
identify a region of the tooth within the image,
detect a target color value indicating color of the tooth region,
determine a target item value based on the target color value and the associated data, and
output the target item value,
wherein the processor is configured to detect color values at a plurality of points within the identified tooth region and set an average of the color values at the plurality of points as the target color value.
